(19) United States
(12) Patent Application Publication
(10) Pub. No.: US 2004/0063436 A1
(43) Pub. Date: Apr. 1, 2004

(54) Telecommunication system with transmit and multi-user diversity

(75) Inventors: Volker Braun, Stuttgart (DE); Cornelis Hoek, Tamm (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/648,447

(22) Filed: Aug. 27, 2003

(30) Foreign Application Priority Data
Sep. 27, 2002 (EP) 02360276.6

(51) Int. Cl. H04Q 7/20; H04B 7/00

(52) U.S. Cl. 455/450; 455/509

(57) ABSTRACT

The present invention relates to a telecommunication system having a first component for providing of a dedicated channel for each one of the plurality of user equipments, a second component for assigning a carrier frequency of a set of at least first and second carrier frequencies to each one of the dedicated channels, a third component for providing of a code-multiplexed shared channel for the plurality of user equipments, a fourth component for sending of one of the first signals to one of the plurality of user equipments on the dedicated channel of that user equipment on the assigned carrier frequency by applying a transmit diversity scheme and a fifth component for sending of one of the second signals to one of the plurality of user equipments on the code-multiplexed shared channel on the carrier frequency being assigned to that user equipment by applying a multi-user diversity scheme.

### FIELD F THE INV NTION

The present invention generally relates to telecommunications, and more particularly, to transmit and multi-user diversity in a cellular mobile telecommunication system. The invention is based on a priority application EP 02 360 276.6. which is hereby incorporated by reference.

### BACKGROUND AND PRIOR ART

The demand for data communication services has exploded with the acceptance and widespread use of the Internet. While data communications have historically been serviced via wired connections, wireless users are now demanding that their wireless units also support data communications. Many wireless subscribers now expect to be able to “surf” the Internet, access their email, and perform other data communication activities using their cellular phones, wireless personal data assistants, wirelessly linked notebook computers, and/or other wireless devices.

Significant performance issues exist when using a wireless network to service data communications. Wireless networks were initially designed to service the well-defined requirements of voice communications. Generally speaking, voice communications require a sustained bandwidth with minimum signal-to-noise ratio (SNR) and continuity requirements. Data communications, on the other hand, have very different performance requirements. Data communications are typically bursty, discontinuous, and may require a relatively high bandwidth during their active portions.

The wireless network infrastructure must support both low bit rate voice communications and the varying rate data communications. More particularly, the network infrastructure must transmit low bit rate, delay sensitive voice communications together with high data rate, delay tolerant rate data communications.

It is therefore desirable to provide a communication system that is capable of carrying both delay sensitive lower data rate voice communications and delay tolerant higher data rate data communications with minimal waste of spectral capacity. Further, it is also desirable to provide a communication system that also services bursty data traffic for a plurality of data users without wasting allocated spectrum.

One example of such a communication system is the Universal Mobile Telecommunications System (UTMS) Terrestrial Radio Access Network (UTRAN). The UTRAN is a third generation system which in some respects builds upon the radio access technology known as Global System for Mobile communications (GSM). UTRAN is a wideband code division multiple access (W-CDMA) system.

A goal of the Third Generation Partnership Project (3GPP) is to evolve further the UTRAN and GSM-based radio access network technologies. Of particular interest here is the support of variable transmission rate services in the third generation mobile radio communications system for both real time and non-real time delay tolerant services. Because users share the same radio resources, the radio access network must carefully allocate resources to individual user equipment (UE) connections based on quality of service requirements, such as variable rate services, and on the availability of radio resources.

For example, in a multimedia session, one bearer may carry a speech connection, another bearer carries a video connection, and a third bearer may carry a packet data connection. Connections are mapped by the UTRAN onto physical transport channels.

Between the UE and the UTRAN, a connection may be mapped to one or more dedicated transport channels (DCHs) or to a common transport channel such as a random access common channel (RACH), a forward access common channel (FACH), a common packet channel (CPCH), a downlink shared channel (DSCH), and a high speed-downlink shared channel (HS-DSCH).

Real time connections are mapped to dedicated channels. On a dedicated channel, resources may be guaranteed to provide a particular service, such as a minimum transmission rate for voice communications.

To provide effective multimedia capabilities in UMTS, the High-Speed Downlink Packet Access (HSDPA) scheme is being developed which facilitates transfer of packet data to a mobile station at up to e.g. 10 Mbps.

The concept of HSDPA has been recently standardized in 3GPP for UMTS. It considers enhancements that can be applied to UTRA to provide very high-speed downlink packet access by means of a high-speed downlink shared channel (HS-DSCH).

For the basic structure of HS-DSCH two architectures have been considered (R2A010010: HSDPA radio interface protocol architecture, Ericsson, Motorola), i.e. an RNC-based architecture consistent with R99 architecture and a node B-based architecture for scheduling. Moving the scheduling to the nodes B enables a more efficient implementation of scheduling by allowing the scheduler to work with the most recent channel information. The scheduler can adapt the modulation to better match the current channel conditions and fading environment. Moreover, the scheduler can exploit the multi-user diversity by scheduling only those users in constructive fades.

To improve transmission in a fading environment diversity techniques based on the use of multiple downlink transmit antennas are well known. Second order applications of these have been applied in the UTRA R99 specifications. Such techniques exploit spatial and/or polarization decorrelations over multiple channels to achieve fading diversity gains.

Multiple input multiple output (MIMO) processing employs multi antennas at both the base station transmitter and terminal receiver, providing several advantages over transmit diversity techniques with multiple antennas only at the transmitter and over single antennas systems. If multiple antennas are available at both the transmitter and the receiver, the peak throughput can be increased using a technique known as code re-use.

It is an object of the present invention to provide an improved transmit diversity technique, in particular for usage in HSDPA-type systems.

### SUMMARY OF THE INVENTION

The present invention provides for an improved transmit diversity technique which enables to make efficient usage of the total available transmission power of the power amplifiers, in particular for providing both real time and non-real time services. In a preferred application of the present invention real time signals, such as voice and/or video signals, are sent out by applying a transmit diversity technique with multiple power amplifiers and multi antennas. Each of the power amplifiers supports at least two carrier frequencies. The real time signals are split up into a group of signals which are sent on the first carrier frequency and into another group of signals which are sent on the second carrier frequency.

Non-real time signals are scheduled in order to exploit multi-user diversity by scheduling only those users in constructive fades. Because of this kind of scheduling no transmit diversity is required. In order to make symmetric usage of the power amplifiers the active user equipments within the cell are split into a group which is assigned to the first transmission frequency and into another group which is assigned to the second transmission frequency. Non-real time signals which are to be sent to the first group of user equipments are amplified by the first power amplifier and non-real time signals to be sent to the second group are amplified by the second power amplifier. Hence, in average the usage of the power amplifiers is about symmetric and efficient usage of the total available transmission power is made.

In accordance with a preferred embodiment of the invention the real time signals are transmitted over DPCHs and the non-real time signals over a shared HS-DSCH of a HSDPA system. The real time signals are transmitted on the DPCHs using transmit diversity and each of the non-real time signals is transmitted over HS-DSCH over only one of the transmission antennas without transmit diversity but applying multi-user diversity. This way statistical balancing of transmission power can be achieved by using multi-carrier power amplifiers.

In accordance with a further preferred embodiment of the invention more than two carrier frequencies are used. The multi-carrier power amplifiers needs to support these carrier frequencies. To obtain statistical balancing of the usage of the transmission power of the power amplifiers the number of carrier frequencies must be equal to the number of diversity branches. For example, instead of a two transmit diversity scheme with a two-carrier power amplifier a four-transmit diversity scheme with a four-carrier power amplifier can be used.

### BRIEF DESCRIPTION OF THE DRAWINGS

In the following preferred embodiments of the invention will be described in greater detail by making reference to the drawings in which:

FIG. 1 is a block diagram of a preferred embodiment of the transmission system of the present invention

FIG. 2 is illustrative of the statistical utilization of the transmission power capacities of the dual carrier power amplifiers of the system of FIG. 1,

FIG. 3 is illustrative of a flow chart of a preferred embodiment of a method of the invention.

### DETAILED DESCRIPTION

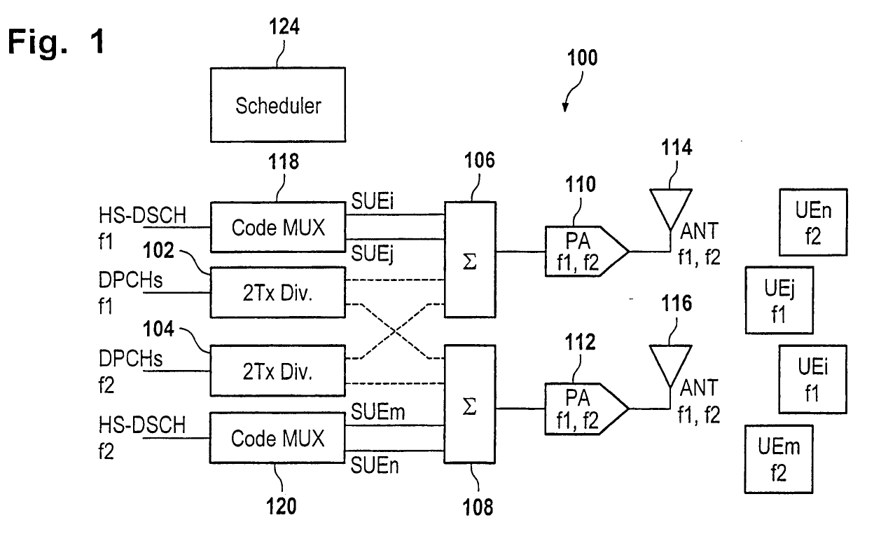

FIG. 1 shows a block diagram of a telecommunication system for servicing a number of mobile user equipments (UEs). By way of example the user equipments UEn UE [symbol] UEi and UEm are shown in the block diagram of FIG. 1; it needs to be noted that in a practical application there can be many more UEs.

Each of the UEs is assigned to a first transmission frequency f1 or a second transmission frequency f2. For example UEn is assigned to f2, UE [symbol] is assigned to f1, UEi is assigned to f1 and UEm is assigned to f2. This way the UEs are split into a first group of UEs which are assigned to the first carrier frequency f1 and into a second group which is assigned to the second carrier frequency f2.

Preferably the assignment of carrier frequencies to UEs is performed by appropriate signaling between the UEs and the transmitter 100 of the telecommunication system. For example carrier frequencies are assigned to UEs which become active alternatingly. For example the UEs become active in the following sequence:

UEi, UEn UE [symbol] , UEm, . . .

The first UE which becomes active, i.e. UEi, is assigned to the first carrier frequency f1. The second UE which becomes active, i.e. UEn is assigned to the second carrier frequency f2. The next UE which becomes active, i.e. UE [symbol] , is assigned to the first carrier frequency f1, and so on. This way the two groups of UEs results, where each group comprises about the some number of UEs if a larger number of UEs is considered.

Preferably the assignment of UEs to frequencies is performed in order to balance the load of the power amplifiers. It is to be noted that this assignment can be dynamic and that FIG. 1 is to be understood as a snap shot.

The transmitter 100 serves to transmit both real time and non-real time signals to the UEs. Real time signals, such as voice or video signals, are transmitted via DPCHs. Each of the DPCH's is assigned to either the first carrier frequency f1 or to the second carrier frequency f2. In order to provide transmit diversity for the DPCHs the transmitter 100 has transmit diversity modules 102 and 104.

Transmit diversity module 102 receives real time signals which are to be transmitted on a DPCH being assigned to the frequency f1. Likewise transmit diversity module 104 receives such real time signals which are to be transmitted on DPCHs being assigned to the second carrier frequency f2.

Transmit diversity module 102 is coupled via adders 106 and 108 to power amplifiers 110 and 112, respectively. Both power amplifiers 110 and 112 are dual-carrier power amplifiers which support the carrier frequencies f1 and f2. Power amplifier 110 is coupled to antenna 114 and power amplifier 112 is coupled to antenna 116. This way any known diversity technique based on the use of multiple downlink transmit antennas can be implemented.

For the HSDSCH the transmitter has code multiplexers 118 and 120. Code multiplexer 118 has an input for receiving of non-real time signals to be sent to the first group of UEs, i.e. to UEs which are assigned to the second carried frequency f2. This way the signal components SUEi, SUE [symbol] , . . . to be transmitted on carrier frequency f1 and the signal components SUEm, SUEn, . . . to be transmitted on carrier frequency f2 are provided by the code multiplexes 118 and 120, respectively. The signal components SUEi, SUE [symbol] , . . . which are to transmitted on carrier frequency f1 are input into adder 106. Likewise the signal components SUEm, SUEn, . . . are input into adder 108.

Further the transmitter 100 has scheduler 124. Scheduler 124 schedules the non-real time signals to be sent over HS-DSCH in order to provide multi-user diversity by scheduling only non-real time signals to users in constructive fades.

In operation, the power amplifier 110 is controlled to amplify the real time signals of the DPCHs being assigned to the frequency f1 on carrier frequency f1 and the real time signal components of the DPCHs assigned to the carrier frequency of f2 on frequency f2. The signal components SUEi, SUE [symbol] , . . . of HS-DSCH to be sent on carrier frequency f1 are only amplified by power amplifier 110 on carrier frequency f1. The same principle applies correspondingly to the operation of power amplifier 112.

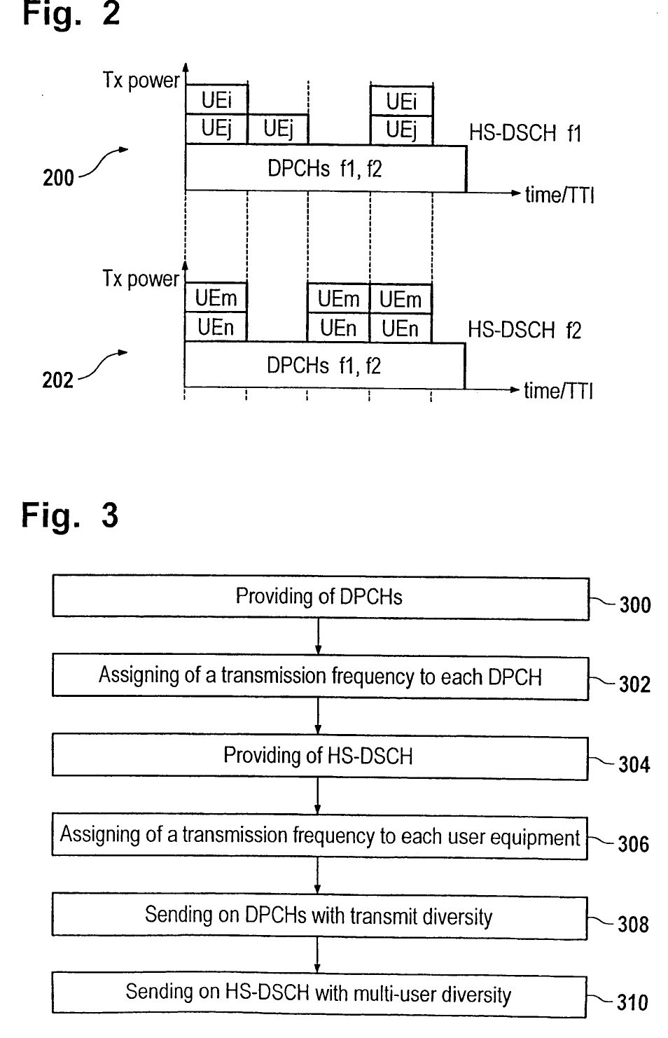

The statistical balancing of the utilization of the total available transmission power is illustrated by way of example in FIG. 2. FIG. 2 shows diagrams 200 and 202 illustrating the utilization of the transmission power of power amplifiers 110 and 112 of FIG. 1, respectively, in the time domain. The time axis is divided into scheduling intervals, which are referred to as transmission time intervals (TTI) in UTRA notation. As it is apparent from FIG. 2 most of the time both power amplifiers 110 and 112 are operated at or close to their respective maximum power output capability.

FIG. 3 illustrates an embodiment of a method of the invention by way of example. In step 300 DPCHs are provided for transmitting of real time signals. A transmission frequency of a set of transmission frequencies is assigned to each one of the DPCHs in step 302. In step 304 a HS-DSCH is provided as a shared channel for transmitting of non-real time signals. In step 306 a transmission frequency of the set of transmission frequencies is assigned to each active UE within the cell. This is done by an appropriate signalling protocol. When the UEs are capable to receive only one carrier frequency this step is not required as the carrier frequency has already been assigned in step 302. In this instance the carrier frequency assigned in step 302 to a UE will also be used for the HS-DSCH transmission to that UE.

In step 308 the real time signals are sent on the DPSCs with transmit diversity. In step 310 the non-real time signals are sent on the shared SH-DSCH with multi-user diversity but without transmit diversity. Due to the assignment of transmission frequencies to user equipment in step 306 a statistical balancing of the utilization of the power amplifiers is accomplished.

### List Of Reference Numerals

| | |
|---|---|
| 100 | transmitter |
| 102 | transmit diversity module |
| 104 | transmit diversity module |
| 106 | adder |
| 108 | adder |
| 110 | power amplifier |
| 112 | power amplifier |
| 114 | antenna |
| 116 | antenna |
| 118 | code multiplexer |
| 120 | code multiplexer |
| 124 | scheduler |
| 200 | diagram |
| 202 | diagram |

1. A method of sending first and second signals to a plurality of user equipments, the method comprising the steps of:
providing of a dedicated channel for each one of the plurality of user equipments,
assigning a carrier frequency of a set of at least first and second carrier frequencies to each one of the dedicated channels,
providing of a code-multiplexed shared channel for the plurality of user equipments,
sending of one of the first signals to one of the plurality of user equipments on the dedicated channel of that user equipment on the assigned carrier frequency by applying a transmit diversity scheme,
sending of one of the second signals to one of the plurality of user equipments on the code-multiplexed shared channel on the carrier frequency being assigned to that user equipment by applying a multi-user diversity scheme.

2. The method of claim 1, the dedicated channels being DSCH type channels and the code-multiplexed shared channel being a HS-DSCH type channel of a HSDPA type transmission system.

3. The method of claim 1, whereby the sending of one of the first signals and the one of the second signals is performed by means of first and second multi-carrier power amplifiers being coupled to first and second antennas, the first and second multi-carrier amplifiers having at least the first and the second carrier frequencies.

4. The method of claim 1, the set of carrier frequencies having a number of n carrier frequencies.

5. A computer program product, in particular digital storage device, having program means for sending of first and second signals to a plurality of user equipments, the program means being adapted to perform the steps of:
providing of a dedicated channel for each one of the plurality of user equipments,
assigning a carrier frequency of a set of at least first and second carrier frequencies to each one of the dedicated channels,
providing of a code-multiplexed shared channel for the plurality of user equipments,
sending of one of the first signals to one of the plurality of user equipments on the dedicated channel of that user equipment on the assigned carrier frequency by applying a transmit diversity scheme,
sending of one of the second signals to one of the plurality of user equipments on the code-multiplexed shared channel on the carrier frequency being assigned to that user equipment by applying a multi-user diversity scheme.

6. A sender for sending of first and second signals to a plurality of user equipments, the sender comprising:
a first component for providing of a dedicated channel for each one of the plurality of user equipments,
a second component for assigning a carrier frequency of a set of at least first and second carrier frequencies to each one of the dedicated channels,
a third component for providing of a code-multiplexed shared channel for the plurality of user equipments,
a fourth component for sending of one of the first signals to one of the plurality of user equipments on the dedicated channel of that user equipment on the assigned carrier frequency by applying a transmit diversity scheme,
a fifth component for sending of one of the second signals to one of the plurality of user equipments on the code-multiplexed shared channel on the carrier frequency being assigned to that user equipment by applying a multi-user diversity scheme.

7. The sender of claim 6 further comprising scheduler means for providing the multi-user diversity for the code-multiplexed shared channel for sending of one of the second signals only when a constructive channel fade is detected.

8. The sender of claim 6, the fourth component for sending of the one of the first signals and the fifth component for sending of the one of the second signals being provided by first and second multi-carrier amplifier components being coupled to first and second antenna components, the first and second multi-carrier amplifiers having at least the first and the second frequencies.

9. The sender of claim 6, the set of carrier frequencies having a number of n carrier frequencies.

10. A mobile cellular telecommunication system for sending of first and second signals to a plurality of user equipments within a cell, the telecommunication system comprising:
a first component for providing of a dedicated channel for each one of the plurality of user equipments,
a second component for assigning a carrier frequency of a set of at least first and second carrier frequencies to each one of the dedicated channels,
a third component for providing of a code-multiplexed shared channel for the plurality of user equipments,
a fourth component for sending of one of the first signals to one of the plurality of user equipments on the dedicated channel of that user equipment on the assigned carrier frequency by applying a transmit diversity scheme,
a fifth component for sending of one of the second signals to one of the plurality of user equipments on the code-multiplexed shared channel on the carrier frequency being assigned to that user equipment by applying a multi-user diversity scheme.
